(19) United States
(12) Patent Application Publication
(10) Pub. No.: US 2024/0113281 A1
(43) Pub. Date: Apr. 4, 2024

(54) AQUEOUS BASED ANODE WITH MECHANICAL ENHANCEMENT ADDITIVES

(71) Applicant: ENEVATE CORPORATION, Irvine, CA (US)

(72) Inventors: Younes Ansari, Irvine, CA (US); Qing Zhang, Mission Viejo, CA (US); Benjamin Yong Park, Irvine, CA (US)

(21) Appl. No.: 17/956,009

(22) Filed: Sep. 29, 2022

(51) Int. Cl. H01M 4/36; H01M 4/62; H01M 10/0525

(52) U.S. Cl. CPC H01M 4/364; H01M 4/62; H01M 10/0525; H01M 2004/021

(57) ABSTRACT

Systems and methods are provided for aqueous based electrodes (e.g., anodes) with mechanical enhancement additives. An electrode for use in an electrochemical cell has an active material that includes silicon and a mechanical enhancement additive, with the mechanical enhancement additive selected to offset or counter silicon volume changes, and with the mechanical enhancement additive selected based on one or more selection thresholds relating to one or both of Young's modulus and aspect ratio.

### TECHNICAL FIELD

Aspects of the present disclosure relate to energy generation and storage. More specifically, certain implementations of the present disclosure relate to methods and systems for aqueous based anode with mechanical enhancement additives.

### BACKGROUND

Various issues may exist with conventional battery technologies. In this regard, conventional systems and methods, if any existed, for designing and producing batteries or components thereof may be costly, cumbersome, and/or inefficient—e.g., they may be complex and/or time consuming to implement, and may limit battery lifetime. In addition, recalls and warranty issues may be costly for products using batteries such as electric vehicles.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for aqueous based anode with mechanical enhancement additives, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1A illustrates an example battery.

FIG. 1B illustrates an example battery management system (BMS) for use in managing operation of batteries.

FIG. 2 is a flow diagram of an example lamination process for forming a silicon-containing or a silicon-dominant cell.

FIG. 3 is a flow diagram of a direct coating process for forming a silicon-containing or a silicon-dominant cell.

FIG. 4 is a graph diagram illustrating cycle life performance of anodes with mechanical enhancement additives compared with control anodes.

FIG. 5 is a graph diagram illustrating half-cell cycling performance of anodes with mechanical enhancement additives compared with control anodes.

### DETAILED DESCRIPTION

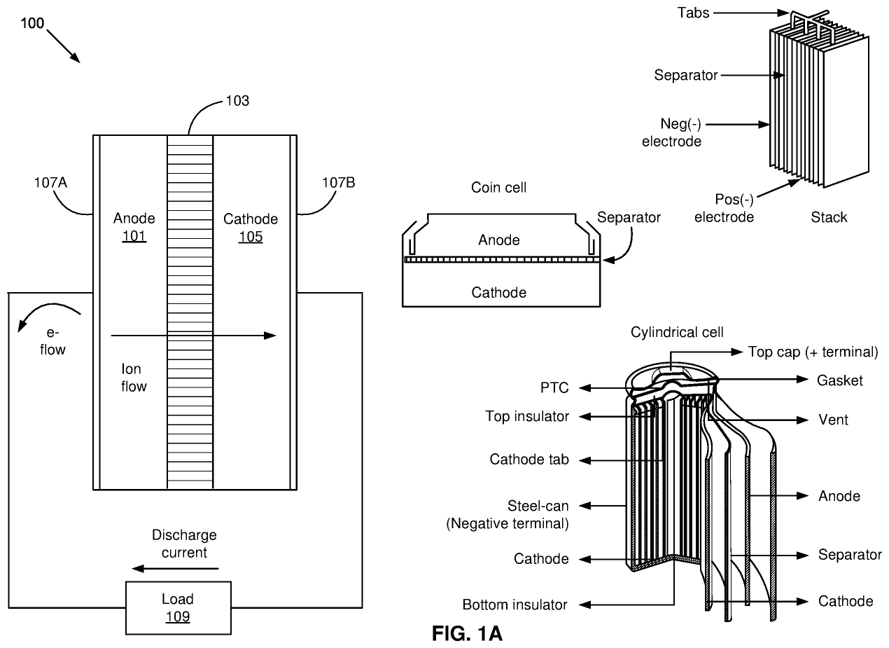

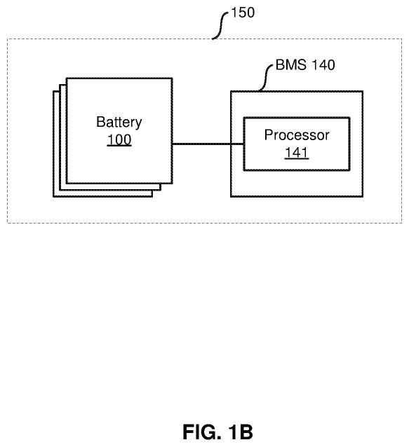

FIG. 1A illustrates an example battery. Referring to FIG. 1A, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1A is a very simplified example merely to show the principle of operation of a lithium-ion cell. Examples of realistic structures are shown to the right in FIG. 1A, where stacks of electrodes and separators are utilized, with electrode coatings typically on both sides of the current collectors except, in certain cases, the outermost electrodes. The stacks may be formed into different shapes, such as a coin cell, cylindrical cell, prismatic pouch cell, or prismatic metal can cell, for example.

The development of portable electronic devices and electrification of transportation drive the need for high-performance electrochemical energy storage. In devices ranging from small-scale (<100 Wh) to large-scale (>10 kWh), Li ion batteries are widely used over other rechargeable battery chemistries due to their advantages in energy density and cyclability.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode 105 are electrically coupled to the current collectors 107A and 107B, which comprise metal or other conductive material for providing electrical contact to the electrodes as well as physical support for the active material in forming electrodes.

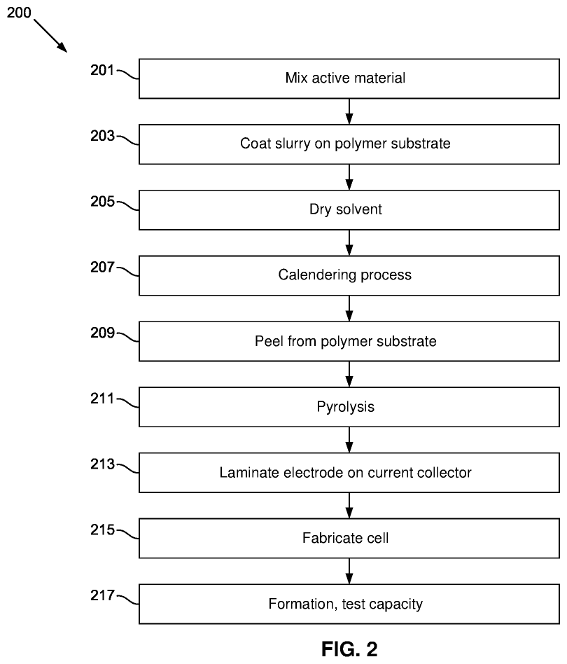

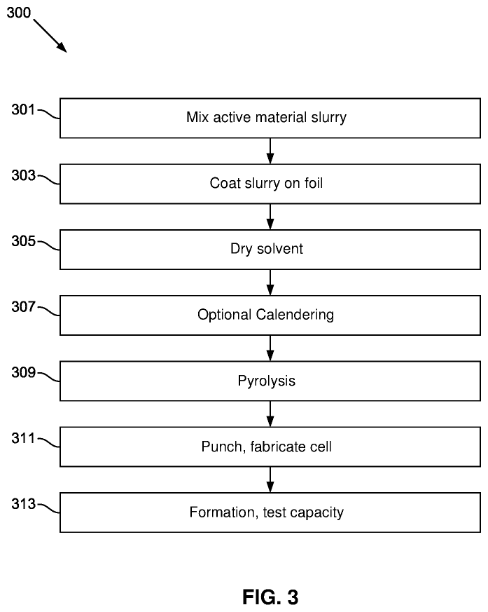

The configuration shown in FIG. 1A illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. In this regard, different methods or processes may be used in forming electrodes, particularly silicon-containing and/or silicon-dominant (>50% in terms of active material by capacity or by weight) anodes. For example, lamination or direct coating may be used in forming a silicon-containing anode (silicon anode). Examples of such processes are illustrated in and described with respect to FIGS. 2 and 3. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄, LiFSI, LiTFSI, etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 4.0 molar (M) and lithium bis(trifluoromethanesulfonyl)imide (LiTFSI) may be present at a concentration of about 0 to 4.0 molar (M). Solvents may comprise one or more cyclic carbonates, such as ethylene carbonate (EC), fluoroethylene carbonate (FEC), or propylene carbonate (PC) as well as linear carbonates, such as ethyl methyl carbonate (EMC), diethyl carbonate (DEC), and dimethyl carbonate (DMC), in various percentages. In some embodiments, the electrolyte solvents may comprise one or more of EC from about 0-40%, FEC from about 2-40% and/or EMC from about 50-70% by weight.

The separator 103 may be soaked with a liquid or gel electrolyte. In addition, in an example embodiment, the separator 103 does not melt below about 100 to 140° C., and exhibits sufficient mechanical properties for battery applications. A battery, in operation, can experience expansion and contraction of the anode 101 and/or the cathode 105. In an example embodiment, the separator 103 can expand and contract by at least about 5 to 10% without tearing or otherwise failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material and a current collector, such as a copper sheet. Carbon is often used because it has excellent electrochemical properties and is also electrically conductive. Anode electrodes currently used in rechargeable lithium-ion cells typically have a specific capacity of approximately 200 milliamp hours per gram (mAh/g). Graphite, the active material used in most lithium-ion battery anodes, has a theoretical energy density of 372 mAh/g. In comparison, silicon has a high theoretical capacity of 4200 mAh/g. In order to increase volumetric and gravimetric energy density of lithium-ion batteries, silicon may be used as the active material for the cathode 105 or anode 101. Si anodes may be in the form of a composite on a current collector, with >50% Si by capacity or weight in the composite layer.

In an example scenario, the anode 101 and cathode 105 store the ions used for separation of charge, such as lithium ions. In this example, the electrolyte carries positively charged lithium ions from the anode 101 to the cathode 105 in discharge mode, as shown in FIG. 1A, and vice versa through the separator 103 in charge mode. The movement of the lithium ions and reactions with the electrodes create free electrons in one electrode which creates a charge at the opposite current collector. The electrical current then flows from the current collector where charge is created through the load 109 to the other current collector. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 through the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density and high power density of lithium-ion batteries are achieved with the development of high-capacity and high-voltage cathodes, high-capacity anodes and electrolytes with high voltage stability and interfacial compatibility with electrodes. Functionally non-flammable or less-flammable electrolytes could be used to improve safety. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be improved by incorporating conductive additives with different morphological properties. Carbon black (Super P), vapor grown carbon fibers (VGCF), and a mixture of the two have previously been incorporated into the anode to improve electrical conductivity and otherwise improve performance. The synergistic interactions between the two carbon materials may facilitate electrical contact throughout the large volume changes of the silicon anode during charge and discharge as well as provide additional mechanical robustness to the electrode and provide mechanical strength (e.g., to keep the electrode material in place). These contact points (especially when utilizing high-aspect-ratio conductive materials) facilitate the electrical contact between anode material and current collector to mitigate the isolation (island formation) of the electrode material while also improving conductivity in between silicon regions. Graphenes and carbon nanotubes may be used because they may show similar benefits. Thus, in some instances, a mixture of two or more of carbon black, vapor grown carbon fibers, graphene, and carbon nanotubes may be used independently or in combinations for the benefits of conductivity and other performance.

State-of-the-art lithium-ion batteries typically employ a graphite-dominant anode which is a lithium intercalation type anode. Silicon-containing and especially silicon-dominant anodes, however, offer improvements compared to graphite-dominant Li-ion batteries. Silicon exhibits both higher gravimetric (4200 mAh/g vs. 372 mAh/g for graphite) and volumetric capacities (2194 mAh/L vs. 890 mAh/L for graphite). In addition, Si has a higher redox reaction potential versus Li compared to graphite, with a voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life. Therefore, silicon anodes require a strong conductive matrix that (a) holds silicon particles together in the anode, (b) is flexible enough to accommodate the large volume expansion and contraction of silicon, and (c) allows a fast conduction of electrons within the matrix.

Therefore, there is a trade-off among the functions of active materials, conductive additives and polymer binders. The balance may be adversely impacted by high energy density silicon anodes with low conductivity and huge volume variations described above. Polymer binder(s) may be pyrolyzed to create a pyrolytic carbon matrix with embedded silicon particles. In addition, the polymers may be selected from polymers that are completely or partially soluble in water or other environmentally benign solvents or mixtures and combinations thereof. Polymer suspensions of materials that are non-soluble in water could also be utilized.

In some embodiments, dedicated systems and/or software may be used to control and manage batteries or packs thereof. In this regard, such dedicated systems may comprise suitable circuitry for running and/or executing control and manage related functions or operations. Further, such software may run on suitable circuitry, such as on processing circuitry (e.g., general processing units) already present in the systems or it may be implemented on dedicated hardware. For example, battery packs (e.g., those used in electric vehicles) may be equipped with a battery management system (BMS) for managing the batteries (or packs) and operations. An example battery management system (BMS) is illustrated in and described in more detail with respect to FIG. 1B.

FIG. 1B illustrates an example battery management system (BMS) for use in managing operation of batteries. Shown in FIG. 1B is battery management system (BMS) 140.

The battery management system (BMS) 140 may comprise suitable circuitry (e.g., processor 141) configured to manage one or more batteries (e.g., each being an instance of the battery 100 as described with respect with FIG. 1A). In this regard, the BMS 140 may be in communication and/or coupled with each battery 100. In some implementations, a separate processor (e.g., a conventional processor, such as an electronic control unit (ECU), a microcontroller unit (MCU), or the like), or several such separate processors, may be used, and may be configured to handle algorithms or control functions with regards to the batteries. In such implementations, such processor(s) may be connected to the batteries, such as through the processor 141, and thus may be treated as part of the BMS 140 and acting as part of processor 141.

In some embodiments, the battery 100 and the BMS 140 may be in communication and/or coupled with each other, for example, via electronics or wireless communication. In some embodiments, the BMS 140 may be incorporated into the battery 100. Alternatively, in some embodiments, the BMS 140 and the battery 100 may be combined into a common package 150. Further, in some embodiments, the BMS 140 and the battery 100 may be separate devices/components, and may only be in communication with one another when present in the same system. The disclosure is not limited to any particular arrangement, however.

FIG. 2 is a flow diagram of an example lamination process for forming a silicon-containing or a silicon-dominant cell. This process employs a high-temperature pyrolysis process on a substrate, layer removal, and a lamination process to adhere the active material layer to a current collector. This strategy may also be adopted by other types of anodes, such as graphite, conversion type anodes, such as transition metal oxides, transition metal phosphides, and other alloy type anodes, such as Sn, Sb, Al, P, etc.

To fabricate an anode, the raw electrode active material is mixed in step 201. In the mixing process, the active material may be mixed with a binder/resin (such as water soluble PI (polyimide), PAI (polyamideimide), carboxymethyl cellulose (CMC), styrene-butadiene rubber (SBR), poly(acrylic acid) (PAA), Sodium Alginate, Phenolic or other water soluble resins and mixtures and combinations thereof), solvent, rheology modifiers, surfactants, pH modifiers, and conductive additives. The materials may comprise carbon nanotubes/fibers, graphene sheets, metal polymers, metals, semiconductors, and/or metal oxides, for example. Silicon powder with a 1-30 or 5-30 μm particle size, for example, may then be dispersed in polyamic acid resin, PAI, or PI (15-25% solids in N-Methyl pyrrolidone (NMP) or deionized (DI) water) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%. The pH of the slurry can be varied from acidic to basic, which may be beneficial for controlling the solubility, conformation, or adhesion behavior of water soluble polyelectrolytes, such as polyamic acid, carboxymethyl cellulose, or polyacrylic acid. Ionic or non-ionic surfactants may be added to facilitate the wetting of the insoluble components of the slurry or the substrates used for coating processes. The particle size and mixing times may be varied to configure the electrode coating layer density and/or roughness.

Furthermore, cathode electrode coating layers may be mixed in step 201, and coated (e.g., onto aluminum), where the electrode coating layer may comprise cathode material mixed with carbon precursor and additive as described above for the anode electrode coating layer. The cathode material may comprise Lithium Nickel Cobalt Manganese Oxide (NMC (also called NCM): LiNiₓCo_{y}Mn_{z}O₂, x+y+z=1), Lithium Iron Phosphate (LFP: LiFePO₄/C), Lithium Nickel Manganese Spinel (LNMO: e.g. LiNi_{0.5}Mn_{1.5}O₄), Lithium Nickel Cobalt Aluminum Oxide (NCA: LiNiₐCo_{b}Al_{c}O₂, a+b+c=1), Lithium Manganese Oxide (LMO: e.g. LiMn₂O₄), a quaternary system of Lithium Nickel Cobalt Manganese Aluminum Oxide (NCMA: e.g. Li[Ni_{0.89}Co_{0.05}Mn_{0.05}Al_{0.01}]O₂, Lithium Cobalt Oxide (LCO: e.g. LiCoO₂), and other Li-rich layer cathodes or similar materials, or combinations thereof. The particle size and mixing times may be varied to configure the electrode coating layer density and/or roughness.

In step 203, the slurry may be coated on a substrate. In this step, the slurry may be coated onto a polyester, polyethylene terephthalate (PET), or Mylar film at a loading of, e.g., 2-4 mg/cm² and then undergo drying in step 205 to an anode coupon with high Si content and less than 15% residual solvent content. This may be followed by an optional calendering process in step 207, where a series of hard pressure rollers may be used to finish the film/substrate into a smoothed and denser sheet of material.

In step 209, the active-material-containing film may then be removed from the PET, where the active material layer may be peeled off the polymer substrate. The peeling may be followed by a pyrolysis step 211 where the material may be heated to, e.g., 600-1250° C. for 1-3 hours, cut into sheets, and vacuum dried using a two-stage process (120° C. for 15 h, 220° C. for 5 h). The peeling process may be skipped if polypropylene (PP) substrate is used, and PP can leave ˜2% char residue upon pyrolysis.

In step 213, the electrode material may be laminated on a current collector. For example, a 5-20 μm thick copper foil may be coated with polyamide-imide with a nominal loading of, e.g., 0.2-0.6 mg/cm² (applied as a 6 wt % varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

In step 215, the cell may be formed. In this regard, the anode may be used to assemble a cell with cathode, separator and electrolyte materials. In some instances, separator with significant adhesive properties may be utilized.

In step 217, the cell may be assessed before being subject to a formation process. The measurements may comprise impedance values, open circuit voltage, and electrode and cell thickness measurements. The formation cycles are defined as any type of charge/discharge of the cell that is performed to prepare the cell for general cycling and is considered part of the cell production process. Different rates of charge and discharge may be utilized in formation steps. During formation, the initial lithiation of the anode may be performed, followed by delithiation. Cells may be clamped during formation and/or cycling.

FIG. 3 is a flow diagram of a direct coating process for forming a silicon-containing or a silicon-dominant cell. This process comprises physically mixing the active material, conductive additive, and binder together, and coating the mixed slurry directly on a current collector before pyrolysis. This example process comprises a direct coating process in which an anode or cathode slurry is directly coated on a copper foil using a binder such as CMC, SBR, PAA, Sodium Alginate, PAI, PI and mixtures and combinations thereof.

In step 301, the active material may be mixed with, e.g., a binder/resin (such as PI, PAI or phenolic), solvent (such as NMP, water, other environmentally benign solvents or their mixtures and combinations thereof), and conductive additives. The materials may comprise carbon nanotubes/fibers, graphene sheets, metal polymers, metals, semiconductors, and/or metal oxides, for example. Silicon powder with a 1-30 μm particle size, for example, may then be dispersed in polyamic acid resin, PAI, PI (15% solids in DI water or N-Methyl pyrrolidone (NMP)) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%.

Furthermore, cathode active materials may be mixed in step 301, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 303, the slurry may be coated on a copper foil. In the direct coating process described here, an anode slurry is coated on a current collector with residual solvent followed by a drying and a calendering process for densification. A pyrolysis step (˜500-800° C.) is then applied such that carbon precursors are partially or completely converted into glassy carbon or pyrolytic carbon. Similarly, cathode active materials may be coated on a foil material, such as aluminum, for example. The active material layer may undergo a drying process in step 305 to reduce residual solvent content. An optional calendering process may be utilized in step 307 where a series of hard pressure rollers may be used to finish the film/substrate into a smoother and denser sheet of material. In step 307, the foil and coating optionally proceeds through a roll press for calendering where the surface is smoothed out and the thickness is controlled to be thinner and/or more uniform.

In step 309, the active material may be pyrolyzed by heating to 500-1000° C. such that carbon precursors are partially or completely converted into glassy carbon. Pyrolysis can be done either in roll form or after punching. If the electrode is pyrolyzed in a roll form, it will be punched into individual sheets after pyrolysis. The pyrolysis step may result in an anode active material having silicon content greater than or equal to 50% by capacity or by weight. In an example scenario, the anode active material layer may comprise 20 to 95% silicon. In another example scenario may comprise 50 to 95% silicon by weight. In step 311, the cell may be formed, which may also include punching the electrode. In this regard, in instances where the current collector foil is not pre-punched/pre-perforated, the formed electrode may be punched. The formed electrode may be perforated with a punching roller, for example. The punched anodes may then be used to assemble a cell with cathode, separator and electrolyte materials. In some instances, separator with significant adhesive properties may be utilized.

In step 313, the cell may be assessed before being subject to a formation process. The measurements may comprise impedance values, open circuit voltage, and cell and/or electrode thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in formation steps.

In accordance with the present disclosure, silicon-dominant electrodes with mechanical enhancement additives may be utilized in energy storage devices, such as silicon-dominant anode based cells/batteries, particularly lithium-ion cells/batteries with silicon-dominant anodes (also referred to herein as “Si/Li batteries” or “Si—Li batteries”). Such mechanical enhancement additives maybe added into the active material used in the lamination process as described with respect to FIG. 2 and/or the active material used in the direct coating process as described with respect to FIG. 3, for example.

In this regard, in various implementations based on the present disclosure, silicon used in silicon-dominant electrodes may be treated to enhance performance of the subsequently formed silicon-dominant electrodes, as well as performance of energy storage devices incorporating these electrodes, with the treatment comprising use of mechanical enhancement additives. In particular, carefully selected additives may be added to the silicon and the other ingredients used in forming the electrodes, with these additives enhancing mechanical characteristics of the formed electrodes, without adversely affecting performance of the formed electrodes and/or the cells/batteries incorporating these electrodes, or even additionally enhancing at least some aspect of the performance.

Use of such additives may be particularly advantageous during cycling of the cells/batteries. In this regard, the severe volume change of Si during cycling of the silicon-dominant anode based cells/batteries may cause damage to the electrodes, whether they are electrodes with conventional binders (e.g., polyvinylidene difluoride (PVDF), Poly(acrylic acid) (PAA), Polyamide-Imide (PAI), Styrene-Butadiene Rubber (SBR), SBR/CMC (carboxymethyl cellulose), Sheet Moulding Compound (SMC), etc.), or electrodes that have been heat-treated to create a pyrolytic carbon matrix therein.

Accordingly, in various implementations based on the present disclosure, mechanical enhancement additives are used to enhance electrodes, with these additives added to the other ingredients, including the silicon, used in forming the electrodes. Use of such additives may address such issues, such as by modifying mechanical characteristics of the formed electrode to better handle such changes, such as by absorbing or resisting the tensile, shear and the compressive stresses during lithiation and delithiation. The use of additives may improve mechanical performance such as by reducing the amount of expansion in the electrode, for example, which in turn protects the electrode during the cycling of the cells/batteries. Alternatively, the use of additives may improve mechanical performance by adding flexibility or otherwise prevent disintegration of the electrode as a result of volume changes in the Si. The use of additives that may improve mechanical performance may also result in improved cycle life.

The additives may be selected based on one or more predefined selection criteria that are determined to ensure enhancing mechanical performance of the electrode, and preferably improve, or at least do not adversely affect, performance of the electrode otherwise. For example, the additive may be selected based on one or more of Young's modulus, high-aspect ratio, and dimensions (e.g., length such as where the additive has nanofiber structure). The additives may need to have high-aspect ratio of more than 5, more than 10, more than 100, have Young's modulus of higher than 250, 300, 400, or 500 Gigapascals (GPa), and/or have length (e.g., when additives have nanofiber structure) of 1 μm, 10 μm, 100 μm, 200 μm, or more. In some instances, the additive may be electrochemically active or may be electrochemically inactive. Example additives that may meet the selection criteria may include, alumina, aluminum nitride, silicon carbide, silicon nitride, etc.

In some example implementations, Aluminum Oxide (Al₂O₃) nanofiber may be used, as it has a high Young's modulus at least 300 GPa and a high aspect ratio ranging from tens to hundreds. For example, Al₂O₃ nanofiber with diameter of 300-900 nm, length>200 μm, aspect ratio is >220, and Young's modulus of about 530 GPa may be used. Adding Al₂O₃ nanofiber may strengthen the carbon matrix mechanically, and reduce the expansion of the anode. This leads to improvement in mechanical (expansion) and electrochemical (cycle fade, etc.) performance.

In an example implementation, slurry comprising mechanical enhancement additives, for use in forming a silicon-dominant anode with mechanical enhancement additives, which may also be used in such testing, may comprise (by weight—that is, wt %) 29.804% Si powder, 69.716% PAI solution (9.5%) in water, 0.331% Al₂O₃ nanofiber, and 0.15% surfactant. The slurry may be prepared and coated on a current collector, such as an electroplated 15 μm copper foil. The coated anode may then be calendered, such as at 80° C., punched to small pouches, and pyrolyzed, such as at 650° C., 5°/min ramp, and 180 min dwell time under Argon (Ar) environment. After pyrolysis, the resultant anode (denoted as and referred to hereinafter as “Anode 1” or “enhanced anode”) may have final loading of 3.45 mg/cm², and may have a final composition of Si/Al₂O₃ nanofiber/carbon=90/1/9. Further, the resultant anode may have a final thickness of about 78.32 μm, and density of about 1.09 g/cm³.

Correspondingly, a non-coated silicon based slurry, for use in forming control anodes, may comprise (by weight) 27.77% Si powder, 72.13% PAI solution (9.5%) in water, and 0.1% surfactant. The slurry may be used in the same way as the carbon coated silicon particles based slurry—that is, with the non-coated silicon based slurry being prepared and coated on a current collector, such as an electroplated 20 μm copper foil, and the coated anode may then be processed in the same way—that is, calendered, such as at 80° C., punched to small pouches, and pyrolyzed, such as at 650° C., 5°/min ramp, and 180 min dwell time under Argon (Ar) environment. After pyrolysis, the resultant anode (denoted as and referred to hereinafter as “Control Anode”) may have final loading of 3.36 mg/cm², and may have a final composition of Si/carbon=90/10. Further, the resultant anode may have a final thickness of about 74.36 μm, and density of about 1.13 g/cm³.

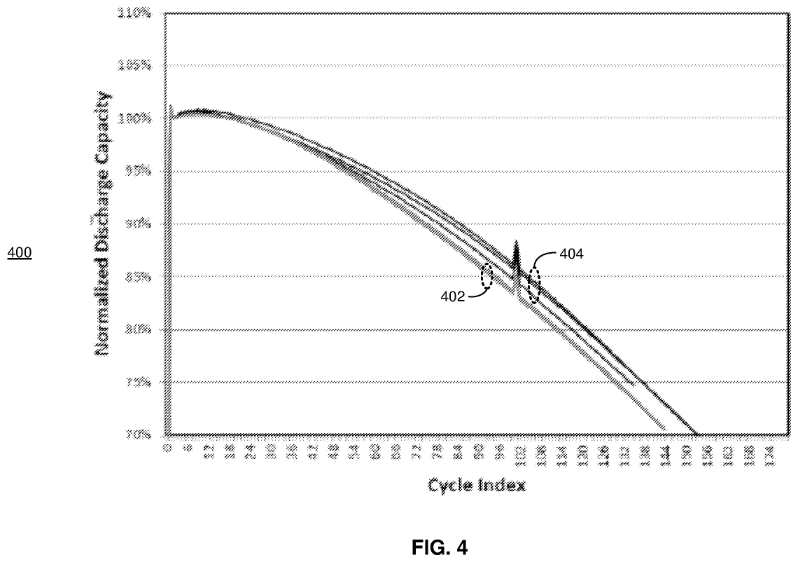

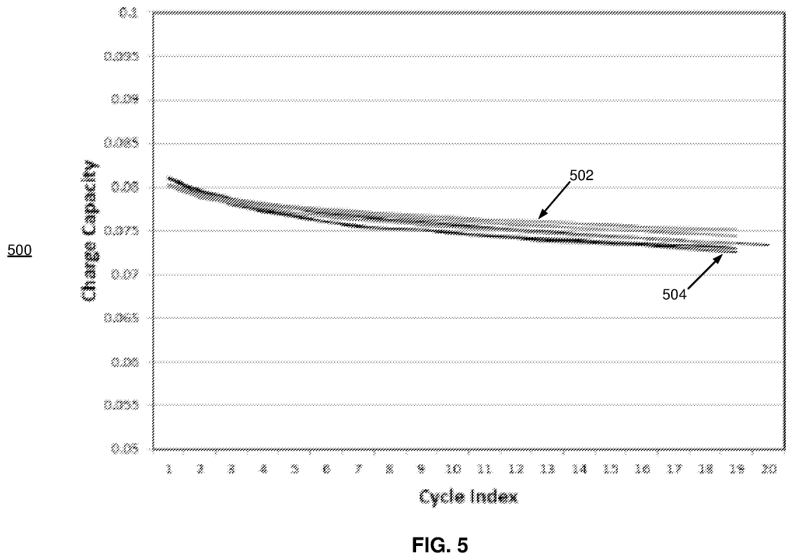

The performance of enhanced anode(s), and improvement therein compared to the control anode(s), is illustrated and described in more detail with respect to FIGS. 4-5.

FIG. 4 is a graph diagram illustrating cycle life performance of anodes with mechanical enhancement additives compared with control anodes. Shown in FIG. 4 is graph 400.

The graph 400 comprises data generated based on an example operation using an anode with mechanical enhancement additives and a control anode (e.g., Anode 1 and the Control Anode as described above) in the same example Si/Li cell (or battery), with graph 400 specifically capturing normalized discharge capacity of the cell as a function of number of cycles.

As illustrated in FIG. 4, the graph 400 includes line graphs 402 and 404, comprising data corresponding to, respectively, use of the control anode having no mechanical enhancement additives (line graphs 402), and use of the enhanced anode with the mechanical enhancement additives (line graphs 404). In this regard, the data captured in graph 400 correspond to cycling of the anodes against a NMC811 (LiNi_{0.8}Mn_{0.1}Co_{0.1}O₂) cathode (e.g., with 92% active ratio and 23 mg/cm² loading) in a pouch cell format. Formation of cells may be performed at 1C for charge and 1C for discharge in the 4.1-2.0 V voltage range, with a 0.05C current taper at the end of charge and a 0.2C current taper at the end of discharge. Constant current cycling may be performed at 0.5C for charge and 0.5C for discharge in the 4.1-2.0 V voltage range. Cell capacity may be 0.074 Ah. As illustrated in graph 400, the coated Si displayed higher capacity and better cycle life compared to the control anode.

FIG. 5 is a graph diagram illustrating half-cell cycling performance of anodes with mechanical enhancement additives compared with control anodes. Shown in FIG. 5 is graph 500.

The graph 500 comprises data generated based on an example operation using anode with mechanical enhancement additives and a control anode (e.g., Anode 1 and the Control Anode as described above) in the same example Si/Li cell (or battery), with graph 500 specifically capturing charge capacity of the cell as a function of number of cycles.

As illustrated in FIG. 5, the graph 500 includes line graphs 502 and 504, comprising data corresponding to, respectively, use of the control anode having no mechanical enhancement additives (line graphs 502), and use of the enhanced anode with the mechanical enhancement additives (line graphs 504). In this regard, the data captured in graph 500 may be obtained based on half-cell test in which the anodes are cycled against lithium metal in a pouch cell format. The constant current cycling may be performed at 0.05C for discharge to 0.05V with 0.09 Ah capacity limit and 0.05C for charge to 1.5V. Consistent with the full cell results illustrated and described with respect to FIG. 4, the anode with the mechanical enhancement additives demonstrated similar capacity retention compared to the control anode.

As illustrated in Table 1, the use of mechanical enhancement additives does not adversely affect the initial Coulombic efficiency (ICE), and the anode with the mechanical enhancement additives may even exhibit improved (higher) initial Coulombic efficiency (ICE) compared to the control anode:

TABLE 1
initial Coulombic efficiency (ICE) from half cells

| Anode | ICE |
|---|---|
| Anode 1 | 90.0% |
| Control Anode | 89.1% |

The anode with the mechanical enhancement additives, however, clearly exhibits improved expansion performance, for example, in XY expansion testing where the anodes are cycled against LiNi_{0.8}Mn_{0.1}Co_{0.1}O₂ (NMC811) cathode (92% active ratio and 23 mg/cm² loading) in a pouch cell format. Formation of cells may be performed at 1C for charge and 1C for discharge in the 4.1-2.0 V voltage range, with a 0.05C current taper at the end of charge and a 0.2C current taper at the end of discharge. Anode dimensions may be measured after the formation process to evaluate expansion along the X and Y axis. As illustrated in Table 2, which shows the XY expansion of Anode 1 and Control Anode, Anode 1 exhibits more than 20% lower XY expansion compared to the Control Anode:

TABLE 2
XY expansion of anodes after formation

| Anode | X % | Y % |
|---|---|---|
| Anode 1 | 1.10% | 0.87% |
| Control Anode | 1.93% | 1.65% |

An example electrode, in accordance with the present disclosure, for use in an electrochemical cell, comprises active material comprising silicon and a mechanical enhancement additive, where the mechanical enhancement additive addresses (e.g., offsets or counters) silicon volume changes, where the mechanical enhancement additive meets one or more performance thresholds relating to, at least, one or more of Young's modulus, aspect ratio, and dimensions of the mechanical enhancement additive. The mechanical enhancement additive may be selected, to address silicon volume changes, with the thresholds relating to, at least, one or more of Young's modulus, aspect ratio, and dimensions used as selection thresholds.

In an example embodiment, the mechanical enhancement additive has Young's modulus higher than 40, 100, 250, 300, 400, or 500 Gigapascals (GPa).

In an example embodiment, the mechanical enhancement additive has aspect ratio of more than 5, more than 10, more than 100.

In an example embodiment, the mechanical enhancement additive is electrochemically active.

In an example embodiment, the mechanical enhancement additive is electrochemically inactive.

In an example embodiment, the mechanical enhancement additive has a length in at least one dimension of 1 μm or more, 10 μm or more, 100 μm or more, or 200 μm or more.

In an example embodiment, the mechanical enhancement additive has a nanofiber structure.

In an example embodiment, the mechanical enhancement additive comprises one or more of alumina, aluminum nitride, silicon carbide, and silicon nitride.

In an example embodiment, the mechanical enhancement additive comprises an Aluminum Oxide (Al₂O₃) nanofiber.

In an example embodiment, the Aluminum Oxide (Al₂O₃) nanofiber has a diameter of 300-900 nm, a length of at least 200 μm, an aspect ratio of at least 100 or 220, and a Young's modulus of at least 100, 200, or 300 GPa.

In an example embodiment, the electrode is a silicon-dominant anode, where the electrochemical cell comprises a lithium-ion cell.

In an example embodiment, the silicon-dominant anode comprises at least 85 or 90% silicon by weight.

In an example embodiment, the silicon-dominant anode comprises at least 1% mechanical enhancement additive by weight.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. An electrode for use in an electrochemical cell, the electrode comprising:
active material comprising silicon and mechanical enhancement additive;
wherein the mechanical enhancement additive addresses silicon volume changes; and
wherein the mechanical enhancement additive meets one or more performance thresholds relating to, at least, one or more of Young's modulus, aspect ratio, and dimensions of the mechanical enhancement additive.

2. The electrode of claim 1, wherein the mechanical enhancement additive has a Young's modulus higher than 40, 100, 250, 300, 400, or 500 Gigapascals (GPa).

3. The electrode of claim 1, wherein the mechanical enhancement additive has aspect ratio of more than 5, more than 10, or more than 100.

4. The electrode of claim 1, wherein the mechanical enhancement additive is electrochemically active.

5. The electrode of claim 1, wherein the mechanical enhancement additive is electrochemically inactive.

6. The electrode of claim 1, wherein the mechanical enhancement additive has a length in at least one dimension of 1 μm or more, 10 μm or more, 100 μm or more, or 200 μm or more.

7. The electrode of claim 1, wherein the mechanical enhancement additive has a nanofiber structure.

8. The electrode of claim 1, wherein the mechanical enhancement additive comprises one or more of alumina, aluminum nitride, silicon carbide, and silicon nitride.

9. The electrode of claim 1, wherein the mechanical enhancement additive comprises an Aluminum Oxide (Al₂O₃) nanofiber.

10. The electrode of claim 9, wherein the Aluminum Oxide (Al₂O₃) nanofiber has a diameter of 300-900 nm, a length of at least 200 μm, an aspect ratio of at least 100 or 220, and a Young's modulus of at least 100, 200, or 300 GPa.

11. The electrode of claim 1, wherein the electrode is a silicon-dominant anode, and wherein the electrochemical cell comprises a lithium-ion cell.

12. The electrode of claim 11, wherein the silicon-dominant anode comprises at least 85 or 90% silicon by weight.

13. The electrode of claim 11, wherein the silicon-dominant anode comprises at least 1% mechanical enhancement additive by weight.
